(19) United States
(12) Patent Application Publication
(10) Pub. No.: US 2018/0274512 A1
(43) Pub. Date: Sep. 27, 2018

(54) Controller Device of Engine Ignition Circuit

(71) Applicant: Sanken Electric Co., LTD., Niiza-shi (JP)

(72) Inventor: Akihiko Futami, Niiza-shi (JP)

(73) Assignee: Sanken Electric Co., LTD., Niiza-shi (JP)

(21) Appl. No.: 15/470,243

(22) Filed: Mar. 27, 2017

(51) Int. Cl. F02P 5/15

(52) U.S. Cl. CPC F02P 5/1518

(57) ABSTRACT

A controller device of an engine ignition circuit includes: a driver circuit that controls a voltage of a control terminal of a first switching element for controlling an ignition timing of an ignition circuit of an engine, based on a timing signal supplied from an engine control unit for controlling the engine; and an auxiliary driver circuit that supplies the timing signal to the control terminal of the first switching element when a battery voltage supplied to the driver circuit becomes equal to or lower than a threshold value.

### TECHNICAL FIELD

This disclosure relates to a controller device of an engine ignition circuit.

### BACKGROUND ART

Japanese Unexamined Patent Application Publication No. S63-259161 discloses an ignition device including: an ignition plug used for a spark ignition engine; an engine ignition circuit including an ignition coil for supplying a voltage to the ignition plug; a switching element for controlling a primary-side current of the ignition coil; and a control circuit for performing on-and-off control of the switching element.

### SUMMARY

In this ignition device, the control circuit operates with using a battery as a power supply. For this reason, when a battery voltage transiently decreases due to noise, the switching element is turned off and the primary-side current of the ignition coil is interrupted during a period in which the battery voltage decreases. Therefore, there is a possibility that ignition may be performed by the ignition plug at an unintended timing.

This disclosure provides a controller device of an engine ignition circuit capable of controlling an ignition timing of the engine with high accuracy even when the battery voltage transiently decreases.

A controller device of an engine ignition circuit according to this disclosure includes: a driver circuit, which controls a voltage of a control terminal of a first switching element for controlling an ignition timing of the ignition circuit of the engine, based on a timing signal supplied from an engine control unit for controlling the engine; and an auxiliary driver circuit, which supplies the timing signal to the control terminal of the first switching element when a battery voltage supplied to the driver circuit becomes equal to or lower than a threshold value.

According to this disclosure, it is possible to provide the controller device of the engine ignition circuit capable of controlling the ignition timing of the engine with high accuracy even when the battery voltage transiently decreases.

### BRIEF DESCRIPTION OF THE DRAWINGS

FIG. 1 is a circuit diagram illustrating a schematic configuration of an ignition system 100 including a controller device 1 of an engine ignition circuit according to an embodiment of this disclosure.

FIG. 2 is a timing chart for explaining an operation of the ignition system 100 illustrated in FIG. 1.

FIG. 3 is a circuit diagram illustrating a schematic configuration of an ignition system 200 which is a modified example of the ignition system 100 illustrated in FIG. 1.

### DETAILED DESCRIPTION

An embodiment of this disclosure will be described below with reference to the drawings.

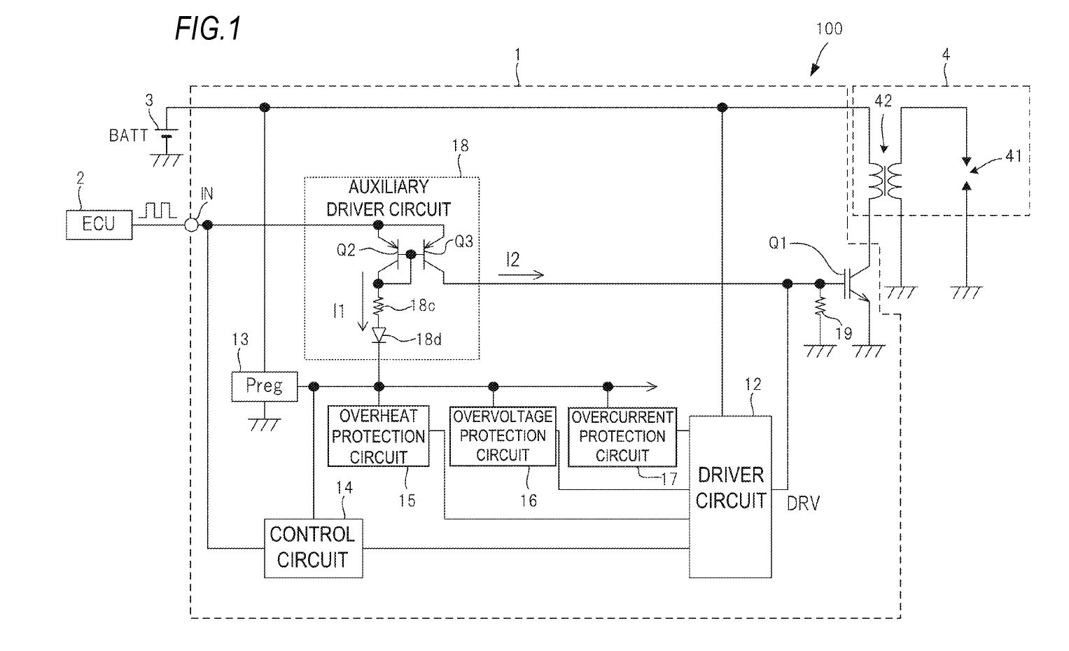

FIG. 1 is a circuit diagram illustrating a schematic configuration of an ignition system 100 including a controller device 1 of an engine ignition circuit according to the embodiment of this disclosure.

The ignition system 100 includes an engine ignition circuit 4 that ignites an air-fuel mixture of fuel and air in a spark-ignition internal combustion engine (engine) mounted on a vehicle (not illustrated) or the like, the controller device 1 that controls the engine ignition circuit 4, an ECU (engine control unit) 2 that is a control unit for controlling the engine, and a battery 3 that supplies a power supply voltage of the controller device 1.

The engine ignition circuit 4 includes an ignition plug 41 and a transformer 42.

One end of a secondary coil of the transformer 42 is grounded, and the other end of the secondary coil of the transformer 42 is connected to an ignition plug 41.

Further, one end of a primary coil of the transformer 42 is connected to the battery 3, and the other end of the primary coil of the transformer 42 is connected to the controller device 1.

The controller device 1 includes: a first switching element Q1 for controlling a timing of ignition performed by the engine ignition circuit 4; a driver circuit 12 that controls a voltage of a control terminal of the first switching element Q1 based on a timing signal supplied from the ECU 2; an auxiliary driver circuit 18; a resistor 19; a control circuit 14, an overheat protection circuit 15, an overvoltage protection circuit 16, and an overcurrent protection circuit 17 which constitute an internal circuit; and an internal-voltage generation circuit (Preg) 13 that generates an internal voltage, to be supplied to the these internal circuits, from a battery voltage of the battery 3.

The first switching element Q1 is an element capable of performing conduction control between input and output by a control of a voltage applied to a control terminal of a bipolar transistor, a MOSFET, or the like, and is made up of an IGBT (Insulated Gate Bipolar Transistor) in the example of FIG. 1.

A collector terminal of the first switching element Q1 is connected to the other end of the primary coil of the transformer 42. An emitter terminal of the first switching element Q1 is grounded. A base terminal of the first switching element Q1 is connected to the output terminal of the driver circuit 12 and the output terminal of the auxiliary driver circuit 18.

The control circuit 14 is operated by the internal voltage supplied from the internal-voltage generation circuit 13, and includes a filter circuit that removes noise of a timing signal input to a signal input terminal IN of the control circuit 1 from the ECU 2 and a waveform shaping circuit that performs waveform shaping of the timing signal after the noise removal. The timing signal output from the waveform shaping circuit is input to the driver circuit 12.

The driver circuit 12 operates according to a battery voltage BATT supplied from the battery 3, and controls a voltage of a base terminal serving as a control terminal of the first switching element Q1, based on the timing signal processed by the control circuit 14.

The timing signal supplied from the ECU 2 is, for example, a rectangular wave signal which periodically repeats a low level (for example, 0 V) and a high level (several volts) as a voltage level.

The driver circuit 12 generates a control signal which becomes a high level at a timing substantially coinciding with a rising timing of this timing signal and becomes a low level at a timing substantially coinciding with a falling timing of this timing signal, and supplies the control signal to the base terminal of the first switching element Q1.

The first switching element Q1 is an N-channel IGBT in the example of FIG. 1. Therefore, the first switching element Q1 is turned on when the voltage of the base terminal is at the high level, whereby a current flows to the primary coil of the transformer 42.

Meanwhile, the first switching element Q1 is turned off when the voltage of the base terminal is at the low level, thereby interrupting a current of the primary coil of the transformer 42. By this interruption operation of the current, ignition of the air-fuel mixture is performed by the ignition plug 41.

A voltage (a voltage when the control signal is at the high level) applied to the base terminal necessary to turn on the first switching element Q1 is set to be equal to the voltage when the timing signal is at the high level.

The overheat protection circuit 15 detects a temperature of the first switching element Q1, and outputs a signal for stopping the operation of the first switching element Q1 to the driver circuit 12 when the temperature becomes equal to or higher than a predetermined set temperature. The driver circuit 12 receives the signal and stops switching of the first switching element Q1.

The overvoltage protection circuit 16 outputs a signal for stopping of the operation of the first switching element Q1 to the driver circuit 12 when the battery voltage BATT exceeds a predetermined value. The driver circuit 12 receives the signal and stops switching of the first switching element Q1.

The overcurrent protection circuit 17 outputs a signal for stopping the operation of the first switching element Q1 to the driver circuit 12 when the current flowing to the first switching element Q1 is equal to or higher than a predetermined value. The driver circuit 12 receives the signal and stops switching of the first switching element Q1.

The auxiliary driver circuit 18 supplies the timing signal supplied from the ECU 2 to the base terminal of the first switching element Q1 when the battery voltage BATT supplied to the driver circuit 12 is equal to or lower than a predetermined threshold value TH, and stops the supply of the timing signal supplied from the ECU 2 to the base terminal of the first switching element Q1 when the battery voltage BATT exceeds the threshold value TH.

The threshold value TH is set as an upper limit value of the operating voltage at which the internal-voltage generation circuit 13 can hardly generate the internal voltage. That is, when the battery voltage BATT is equal to or lower than the threshold value TH, the internal-voltage generation circuit 13 can hardly generate the internal voltage and stops the operation.

Meanwhile, the threshold value TH is set as an upper limit value of the operating voltage at which the driver circuit 12 can hardly turn on the first switching element Q1.

In the example of FIG. 1, the auxiliary driver circuit 18 includes a second switching element Q2 that is connected between the signal input terminal IN and the output terminal of the internal-voltage generation circuit 13, a third switching element Q3 that constitutes a current mirror circuit together with the second switching element Q2, a resistor 18c, and a back flow preventing diode 18d.

The second switching element Q2 and the third switching element Q3 are elements capable of performing conduction control between input and output by a control of a voltage applied to a control terminal of a bipolar transistor, a MOSFET, or the like, and are made up of a PNP-type bipolar transistor in the example of FIG. 1.

An emitter terminal of the second switching element Q2 is connected to the signal input terminal IN. A collector terminal of the second switching element Q2 is connected to one end of the resistor 18c. A base terminal of the second switching element Q2 is connected to the collector terminal of the second switching element Q2 and the base terminal of the third switching element Q3.

An anode of the back flow preventing diode 18d is connected to the other end of the resistor 18c. A cathode of the back flow preventing diode 18d is the output terminal of the internal-voltage generation circuit 13.

An emitter terminal of the third switching element Q3 is connected to a connection point between the signal input terminal IN and the emitter terminal of the second switching element Q2. A collector terminal of the third switching element Q3 is connected to the base terminal of the first switching element Q1.

An operation of the ignition system 100 configured as described above will be described.

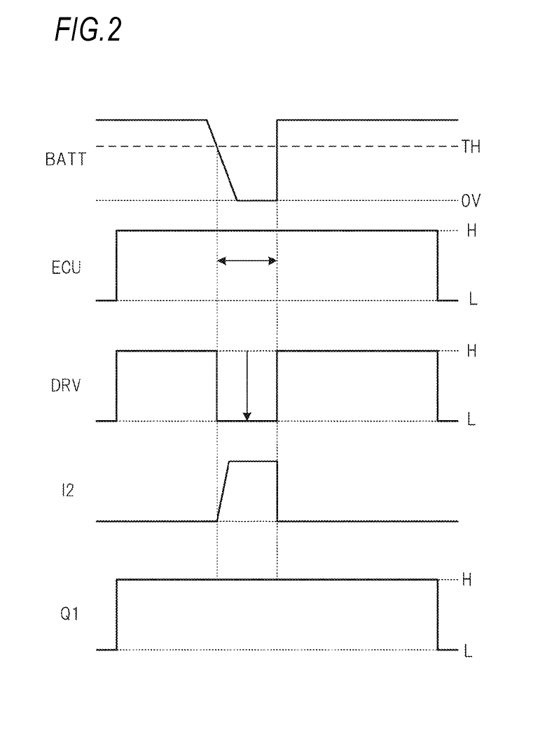

FIG. 2 is a timing chart for explaining the operation of the ignition system 100 illustrated in FIG. 1.

A waveform of “BATT” illustrated in FIG. 2 indicates the battery voltage BATT supplied to the controller device 1. A waveform of “ECU” illustrated in FIG. 2 indicates the timing signal input to the signal input terminal IN from the ECU 2. A waveform of “DRV” illustrated in FIG. 2 indicates the control signal supplied to the base terminal of the first switching element Q1 from the driver circuit 12 of the controller device 1.

A waveform of “I2” illustrated in FIG. 2 indicates the signal supplied to the base terminal first switching element Q1 from the auxiliary driver circuit 18 of the controller device 1. A waveform of “Q1” illustrated in FIG. 2 indicates the voltage of the base terminal of the first switching element Q1.

In the ignition system 100, the driver circuit 12 operates in a steady state in which the battery voltage BATT exceeds the threshold value TH. For this reason, the first switching element Q1 is controlled to turn on and off by the driver circuit 12 at a timing synchronous with the timing signal.

Further, in this steady state, a current does not flow to the second switching element Q2 and the third switching element Q3 of the auxiliary driver circuit 18 due to the internal voltage generated by the internal-voltage generation circuit 13. For this reason, the timing signal input to the signal input terminal IN is not supplied to the base terminal of the first switching element Q1, and the first switching element Q1 is controled to turn on and off by the driver circuit 12.

Meanwhile, as illustrated in FIG. 2, when the battery voltage BATT reaches the threshold value TH and then decreases to 0 V during a period at which the timing signal (ECU) is at the high level, the driver circuit 12 stops operating. Therefore, a level of the control signal (DRV) output from the driver circuit 12 changes to a low level L (0 V).

In addition, when the battery voltage BATT is equal to or lower than the threshold value TH, the internal-voltage generation circuit 13 stops the generation of the internal voltage, and thus the internal voltage starts to decrease. When the internal voltage decreases and the internal voltage becomes a voltage obtained by subtracting a VBE on-voltage of the second switching element Q2 and a forward voltage of the back flow preventing diode 18d from the high level of the ECU 2, the operation of the auxiliary driver circuit 18 starts.

When the auxiliary driver circuit 18 operates, the timing signal (“I1” in FIG. 1) supplied from the ECU 2 flows to the second switching element Q2 of the auxiliary driver circuit 18. Then, a mirror signal I2 having the same level as the timing signal flows to the third switching element Q3, and the mirror signal I2 is input to the base terminal of the first switching element Q1.

For this reason, even during a period at which the battery voltage BATT is equal to or lower than the threshold value TH and the driver circuit 12 is stopped, the base terminal of the first switching element Q1 is maintained at the high level.

Thereafter, when the battery voltage BATT returns to the steady state after exceeding the threshold value, the driver circuit 12 restarts a switching control based on the timing signal, and the internal-voltage generation circuit 13 restarts the generation of the internal voltage.

Thus, the output of the mirror signal I2 from the auxiliary driver circuit 18 is stopped, and the first switching element Q1 returns to a state of being controlled by the control signal supplied from the driver circuit 12.

As described above, according to the ignition system 100, even in a case where the battery voltage BATT transiently decreases and the driver circuit 12 can hardly operate, the driving of the first switching element Q1 can be maintained by the timing signal supplied from the ECU 2. Therefore, an ignition timing of the engine can be controlled with high accuracy.

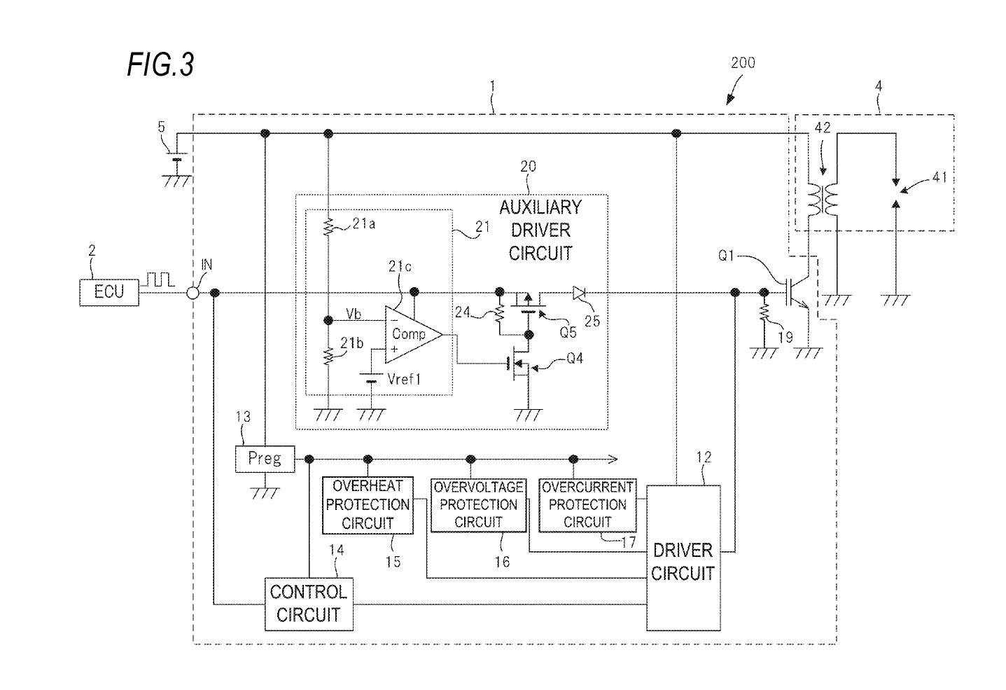

FIG. 3 is a circuit diagram illustrating a schematic configuration of an ignition system 200 according to a modified example of the ignition system 100 illustrated in FIG. 1.

The ignition system 200 illustrated in FIG. 3 has the same configuration as the ignition system 100 except that the auxiliary driver circuit 18 of the controller device 1 is replaced with an auxiliary driver circuit 20. In FIG. 3, the same components as those in FIG. 1 are denoted by the same reference numerals, and the description thereof will not be presented.

The auxiliary driver circuit 20 has substantially the same function as the auxiliary driver circuit 18, but has a circuit configuration different from that of the auxiliary driver circuit 18.

The auxiliary driver circuit 20 includes a battery voltage decrease detection circuit 21 for detecting that the battery voltage BATT supplied to the driver circuit 12 has become equal to or lower than a threshold voltage Vref1 and outputting a detection signal, a resistor 24, a back flow preventing diode 25, a fourth switching element Q4, and a fifth switching element Q5.

The battery voltage decrease detection circuit 21 includes a battery voltage detecting resistor 21a, a battery voltage detecting resistor 21b, and a comparator 21c.

The battery voltage detecting resistor 21a and the battery voltage detecting resistor 21b are connected in series, the battery voltage detecting resistor 21a is connected to the battery 5, and the battery voltage detecting resistor 21b is grounded.

An inverting input terminal of the comparator 21c is connected to a connection point between the battery voltage detecting resistor 21a and the battery voltage detecting resistor 21b. The threshold voltage Vref1 is input to a non-inverting input terminal of the comparator 21c.

The comparator 21c operates with using a high-level timing signal input to the signal input terminal IN, as a power supply. The comparator 21c compares a voltage Vb, which is obtained by resistively dividing the battery voltage BATT with using the battery voltage detecting resistor 21a and the battery voltage detecting resistor 21b, with the threshold voltage Vref1.

The comparator 21c outputs the high-level signal, which is the detection signal, when the voltage Vb becomes equal to or lower than the threshold voltage Vref1.

The threshold voltage Vref1 is set to a value (for example, a value corresponding to 80% of the operating voltage) lower than the operating voltage required for the operation of the driver circuit 12.

The fourth switching element Q4 and the fifth switching element Q5 are elements capable of performing conduction control between input and output by a control of a voltage applied to a control terminal of a bipolar transistor, a MOSFET, or the like, and are made up of an N-channel MOSFET in the example of FIG. 3.

A source terminal of the fifth switching element Q5 is connected to the signal input terminal IN. A drain terminal of the fifth switching element Q5 is connected to a base terminal of the first switching element Q1 through the back flow preventing diode 25. A gate terminal of the fifth switching element Q5 is connected to the source terminal of the fifth switching element Q5 through the resistor 24.

A source terminal of the fourth switching element Q4 is grounded. A drain terminal of the fourth switching element Q4 is connected to the gate terminal of the fifth switching element Q5. A gate terminal of the fourth switching element Q4 is connected to the output terminal of the comparator 21c.

In the auxiliary driver circuit 20 configured as described above, the fourth switching element Q4 is turned off and the fifth switching element Q5 is turned off in a steady state in which the battery voltage BATT exceeds the threshold voltage Vref1.

Therefore, in this steady state, the timing signal from the ECU 2 is not supplied to the base terminal of the first switching element Q1, and the first switching element Q1 is controlled to turn on and off by the control signal from the driver circuit 12.

Meanwhile, in the non-steady state where the battery voltage BATT is equal to or lower than the threshold voltage Vref1, the driver circuit 12 stops, the output of the comparator 21c becomes a high level, then the fourth switching element Q4 is turned on, and thus the fifth switching element Q5 is turned on. As a result, the timing signal from the ECU 2 is in a state of being supplied to the base terminal of the first switching element Q1.

Therefore, in this non-steady state, the first switching element Q1 is in a state of being controlled to turn on and off by the timing signal supplied from the ECU 2.

As described above, according to the ignition system 200, even when the battery voltage BATT transiently decreases and the driver circuit 12 can hardly operate, the first switching element Q1 can be continuously driven by the timing signal supplied from the ECU 2. For this reason, an ignition timing of the engine can be controlled with high accuracy.

The configuration of the battery voltage decrease detection circuit 21 in the auxiliary driver circuit 20 of the ignition system 200 is merely an example, and any circuit may be provided without being limited to such a configuration as long as the circuit can detect that the battery voltage BATT becomes equal to or lower than the threshold voltage Vref1.

In the controller device 1 of the ignition system 100 or 200, portions other than the first switching element Q1 may be provided in the form of a single chip. That is, the first switching element Q1 may be provided outside the controller device 1.

Although this disclosure is described with reference to the specific embodiment, the above-described embodiment is merely an example and can be modified and implemented without departing from the spirit of this disclosure.

As described above, the following items are disclosed in this specification.

(1) A controller device of an engine ignition circuit including: a driver circuit, which controls a voltage of a control terminal of a first switching element for controlling an ignition timing of the ignition circuit of the engine, based on a timing signal supplied from an engine control unit for controlling the engine; and an auxiliary driver circuit, which supplies the timing signal to the control terminal of the first switching element when a battery voltage supplied to the driver circuit becomes equal to or lower than a threshold value.

(2) The controller device of the engine ignition circuit according to (1), further including: an internal-voltage generation circuit, which is operated by a voltage exceeding the threshold value and generates an internal voltage from the battery voltage to supply the generated internal voltage to internal circuits other than the driver circuit, wherein the auxiliary driver circuit includes: a second switching element that is connected between a signal input terminal, to which the timing signal is input, and an output terminal of the internal-voltage generation circuit; and a third switching element that constitutes a current mirror circuit together with the second switching element, and wherein an output terminal of the third switching element is connected to the control terminal of the first switching element.

(3) The controller device of the engine ignition circuit according to (1), wherein the auxiliary driver circuit includes: a battery voltage decrease detection circuit for detecting that the battery voltage becomes equal to or lower than the threshold value and outputs a detection signal; and a switching element connected between a signal input terminal, to which the timing signal is input, and the control terminal and is turned on by receiving the detection signal.

(4) The controller device of the engine ignition circuit according to (1), further including the first switching element.

1. A controller device of an engine ignition circuit comprising:
a driver circuit, which controls a voltage of a control terminal of a first switching element for controlling an ignition timing of the ignition circuit of the engine, based on a timing signal supplied from an engine control unit for controlling the engine; and
an auxiliary driver circuit, which supplies the timing signal to the control terminal of the first switching element when a battery voltage supplied to the driver circuit becomes equal to or lower than a threshold value.

2. The controller device of the engine ignition circuit according to claim 1, further comprising:
an internal-voltage generation circuit, which is operated by a voltage exceeding the threshold value and generates an internal voltage from the battery voltage to supply the generated internal voltage to internal circuits other than the driver circuit,
wherein the auxiliary driver circuit includes: a second switching element that is connected between a signal input terminal, to which the timing signal is input, and an output terminal of the internal-voltage generation circuit; and a third switching element that constitutes a current mirror circuit together with the second switching element, and
wherein an output terminal of the third switching element is connected to the control terminal of the first switching element.

3. The controller device of the engine ignition circuit according to claim 1,
wherein the auxiliary driver circuit includes: a battery voltage decrease detection circuit for detecting that the battery voltage becomes equal to or lower than the threshold value and outputs a detection signal; and a switching element connected between a signal input terminal, to which the timing signal is input, and the control terminal and is turned on by receiving the detection signal.

4. The controller device of the engine ignition circuit according to claim 1, further comprising:
the first switching element.
